(19) United States
(12) Patent Application Publication
(10) Pub. No.: US 2026/0055247 A1
(43) Pub. Date: Feb. 26, 2026

(54) FILMS CONTAINING PLANT PROTEIN AND PVA

(71) Applicant: XAMPLA LIMITED, Cambridge (GB)

(72) Inventors: Marc RODRIGUEZ GARCIA, Cambridge (GB); Nigel SOMERVILLE ROBERTS, Cambridge (GB)

(73) Assignee: XAMPLA LIMITED, Cambridge (GB)

(21) Appl. No.: 19/305,313

(22) Filed: Aug. 20, 2025

Related U.S. Application Data
(60) Provisional application No. 63/685,605, filed on Aug. 21, 2024.

(30) Foreign Application Priority Data
Aug. 21, 2024 (LU) LU103360

(51) Int. Cl. C08J 5/18; C08J 3/07; C08J 3/12; C08K 5/053

(52) U.S. Cl. CPC C08J 5/18; C08J 3/07; C08J 3/12; C08K 5/053; C08J 2389/00; C08J 2429/04

(57) ABSTRACT

The invention relates to a process for forming a film comprising the steps of (a) modifying plant protein material by (i) reducing the d₅₀ mean particle size by volume distribution of the plant protein material to less than 30 mm, preferably less than 20 mm, more preferably less than 10 mm, and/or (ii) reducing the proportion of beta-sheets in the plant protein material by greater 5% as compared to the initial plant protein material; wherein modifying the plant protein material is carried out by milling the plant protein material; (b) contacting the modified plant protein material with PVA and water to form an aqueous film-forming dispersion; (c) drying the aqueous film-forming dispersion to form a film; wherein the aqueous film-forming dispersion also comprises plasticizer. The invention also relates to films obtained by said method. The films have improved biodegradability and good physical properties.

### CROSS-REFERENCE TO RELATED APPLICATIONS

The present application claims priority to U.S. Provisional Application No. 63/685,605, filed Aug. 21, 2024 and Luxembourg Patent Application No. LU103360 filed on Aug. 21, 2024 of which both applications are incorporated herein by reference in their entirety.

### FIELD OF THE INVENTION

The present invention relates to films containing modified plant protein material and PVA, wherein the films have improved biodegradability and acceptable physical properties. The films are suitable for use in the packaging of consumer goods.

### BACKGROUND OF THE INVENTION

Polyvinyl alcohol (referred to in the literature as PVA or PVOH), a polymer derived from the hydrolysis of polyvinyl acetate and having the generic formula [CH2CH(OH)]n is the most commonly used water dispersible synthetic polymer to produce films, particularly for use in making detergent laundry pods. PVA is available in a number of different grades of different degrees of hydrolysis, molecular weights and purities. The choice of grade influences the physical and chemical properties of PVA, including its solubility, viscosity, thermal properties, film-forming ability and the properties of the film that can be formed. The degree of hydrolysis (DH) of PVA refers to the extent to which the acetate groups in the polyvinyl acetate precursor have been replaced by hydroxyl groups through hydrolysis (i.e., it quantifies the percentage of acetate groups that have been converted to alcohol groups).

The term PVA is used to describe polyvinyl alcohol itself as well as co-polymers of polyvinyl alcohol and polyvinyl acetate. Most PVA is formed by hydrolysis of polyvinyl acetate and the degree of hydrolysis of the polyvinyl acetate can be adjusted to alter the properties, such as solubility, of the resulting PVA. The degree of hydrolysis of PVA used in films is in the range 70-99% and more preferably 75-98%. Cold water soluble PVA typically has a DH between 85-90%, preferably 88% (i.e., 88% polyvinyl alcohol and 12% polyvinyl acetate). Hot water soluble PVA typically has a DH of above 95%, typically 98%. Factors which change the DH will change the solubility of the PVA. This has been an issue in some PVA films used to package high/low pH products on extended storage when the DH has increased over time and reduced the solubility. Some materials, such as boric acid, can cross-link PVA and also reduce solubility.

PVA is typically dissolved in water and blended with plasticisers prior to being cast as a film and dried. Some grades of PVA can be blown-extruded but this is only true for certain grades and the compositions that can be formed are much more limited than for solution-cast films.

The polymer molecular weight is also an important parameter as it influences the physical properties of PVA, particularly its physical properties such as film strength. Preferably, the average molecular weight (as measured by gel permeation chromatography) of PVA is 1,000 Da to 100,000 Da, more preferably 5,000 Da to 70,000 Da, more preferably 10,000 to 60,000 Da, more preferably 15,000 to 50,000 Da, more preferably 20,000 to 40,000 Da, even more preferably 25,000 to 30,000 Da. Blends of PVA having different molecular weights can be combined to adjust the physical and chemical properties of the film. High molecular weight PVA typically has good physical properties such as elongation and tear resistance whereas lower molecular weight PVA typically has better solubility.

PVA used in packaging can also be modified with dispersibility-enhancing compounds such as butenediol-vinyl alcohol copolymers (BVOH); and polyalkylene oxides, such as polyethylene oxides (with a molecular weight in the range of 50,000 Da to 400,000 Da) or polyethylene glycols (PEG). PVA polymers can also be modified with other side groups replacing acetate groups to further improve solubility under stressed conditions. PVA films also include plasticisers, typically at levels between 10 wt % and 40 wt %. Suitable plasticisers include water, glycerol, sorbitol, propane-1,2-diol, propane-1,3-diol, 2-methyl-1,3-propanediol, ethylene glycol, glycerol formal and mixtures thereof.

Soluble or water dispersible grades of PVA are widely used as materials for soluble packaging films. Uses of such films include wrapping dishwasher and detergent portions to form unit dose compositions. When the unit dose product is placed in the washing machine or dishwasher and contacted with water, the PVA film will dissolve and release the contents. Typically, the unit dose products are formed by heat sealing or by solvent/adhesive sealing the films together. Films which may not be suitable for heat sealing under the desired production conditions may often be sealed using solvent or adhesive sealing. A mixture of solvents (for solvent sealing) or solvents and dissolved polymer(s) (for adhesive sealing) is applied to one or both surfaces of the films which are then pressed together. There can sometimes be little practical difference between these two. Heat is also typically applied during solvent/adhesive sealing. Solvent/adhesive sealing processes are typically used in high-speed production processes, such as pouch forming using a Drum Former from Cloud or a Hydroforma pod maker from Mespack, or continuous Horizontal-Form-Fill-Seal equipment designs.

Many packing companies use Vertical-Form-Fill Seal (VFFS) or Horizontal-Form-Fill Seal (HFFS) packing lines which use heat sealing to form the sachets. Suitable films for use in such equipment may also be prepared in accordance with the present invention.

In the VFFS process, film is drawn through the packing equipment vertically and folded together and sealed to form the sachet. Typically, a strip of film is folded around the filling head and sealed to form a cylinder or tube which is then sealed at the base, filled with the contents through the filling head and the top is then sealed. This approach can be used for both powders and liquids. The need to “pull” film through the equipment means that the film needs to have a minimum strength. The film cannot stretch too much otherwise it becomes very hard to control the correct positioning and alignment of the film. The film cannot be sticky to the touch as otherwise the friction on the film as the film is pulled through the equipment is too high. This means that spraying or applying a coating to one surface as the film strip is pulled through the packing line is just not practical.

HFFS equipment is very similar to VFFS equipment but the film travels in a horizontal direction. It is particularly useful to pack solid type commodities such as chocolate bars, etc.

PVA is widely used as a film forming polymer due to its excellent physical characteristics, good stability and general ease of processability. One important issue for any packaging film is the stability of the film in high ambient humidities. Any film for packaging of consumer articles must display reasonable robustness and ability to withstand high humidities without excessive changes in physical properties.

Reduction of the level of PVA in a film is typically desirable as ethylene (usually though not always a fossil fuel derived material) is used as a feedstock and it would be advantageous from an environmental perspective to reduce our use of carbon from fossil fuels as compared to renewable plant sources. In addition, the biodegradability of PVA can be an issue under some conditions. Despite the common perception that once a plastic film has dissolved in water then it must automatically degrade, there are conditions under which PVA can remain in the environment, such as in river sediment, for very extended periods of time. This is more typical for high molecular weight PVA and PVA that has been subjected to increased chemical modification.

There is therefore an interest in the development film compositions that have improved biodegradability but which still retain sufficient of the original beneficial physical properties of PVA to be processed and handled using current equipment and in a similar manner to current products packaged in PVA-based films.

One option to achieve this goal of improved film compositions is to include materials that have improved biodegradability and are based on renewable carbon sources compared to PVA into the film. Materials can include carbohydrates such as sugars and starches and celluloses such as HPMC. This has been explored in the art. A common problem with many such blends, when formed into films, is that whilst they do improve the overall biodegradability of the film (by diluting the amount of PVA), the films are typically susceptible to higher levels of humidity and/or have reduced physical properties, such as elongation or tensile strength, as compared to PVA films. Some compositions, such as some PVA/starch blends, can be difficult to make as homogenous films as the different materials may phase separate during film drying, thus reducing quality.

There has been considerable work on the incorporation of biodegradable protein materials into PVA but such films are typically not yet commercially available indicating continued non-optimal outcomes. There is particular benefit of developing processes and products that use readily available plant proteins as the biodegradable materials. Plant proteins are larger, less soluble and more hydrophobic than animal proteins and typically have a globular structure due to the folding of the more hydrophobic protein. There is interest and benefit in the development of improved PVA: plant protein blends and products made from such blends and ways of forming such blends.

Casein: PVA films have been successfully made by dissolved PVA in water and casein in solvent and then blending the solutions. However, casein is a soluble and easy to process animal-derived protein. As an animal-derived protein it does not have universal acceptance, supplies are more limited than for plant-based materials and the properties of casein are too different from globular plant proteins to be re-applicable.

### PRIOR ART

In Food Bioscience 2023, 55, 102962, Yan et al. describe the mixture of soy protein isolate (SPI) and the extracts of the waste Xanthoceras sorbifolia husk to fabricate composite films via a casting method. Polyvinyl alcohol (PVA) was further incorporated to establish ternary composite films, and the influence of PVA content (0%, 0.2%, 0.4%, 0.6%, and 0.8% w/v) on the film performance was well evaluated. The addition of the low level of PVA to the protein and husk films improved the properties of the protein husk films but the PVA is a minor additive and these are protein: husk films with different behaviours and properties compared to conventional PVA films.

In Scientific Reports 2017, 7, 44289, Liu et al. describe a study to develop novel soy protein isolate-based films for packaging using halloysite nanotubes (HNTs), poly-vinyl alcohol (PVA), and 1,2,3-propanetriol-diglycidyl-ether (PTGE). The results highlighted the synergistic effects of SPI, HNTs, PVA, and PTGE on the mechanical properties, water resistance, and thermal stability of SPI films, which showed excellent strength and flexibility. However, the improvement in the physical properties is strongly correlated with the specific chemistry and cross-linking effect of the PTGE and hence is not broadly applicable.

CN104479159A—as an illustrative example-provides a preparation method for a polyvinyl alcohol/soybean protein isolate (PVA/SPI) composite membrane. In this process, the SPI is mixed with water at high temperature, mixed with PVA solution and the pH of the mix is then increased to highly alkaline conditions with caustic with stirring to solubilise the protein prior to casting. There is no information on the solubility of the resulting film, especially after extended storage.

CN101715870 describes a process for cross-linking soy protein with collagen using glutaraldehyde to form a composite material which is then milled and mixed with PVA. The objective is to make an edible sausage casing, and the final material is a soy protein: collagen composite material reinforced by a low level of PVA.

Chen et al in Polymers, 2019, 11, 2096 used a similar approach when preparing PVA: cottonseed protein films. Cottonseed protein was extracted by alkaline solubilisation, precipitation and washing followed by freeze drying. A dilute solution of cottonseed protein was then prepared by dissolving the protein in a pH 10 solution (as inherently alkaline soluble) before mixing the protein solution into a PVA solution. This work showed the large benefit of TEA as a plasticiser on increasing the strength of the composite film. The need to use TEA to get maximum performance will limit the applicability of such composite films.

These methods typically use dilute solutions of protein and/or PVA to ensure intimate mixing of the protein and PVA, meaning high levels of water need to be evaporated. This may not be an issue in a lab but would be very unsuitable for large-scale production processes.

Processes and methods that rely on high pH treatment of the protein in-situ will inherently result in the dried film being alkaline. This may be acceptable for some applications, but may also cause undesirable interactions with products packaged within the film, or possible insolubilisation of the PVA on storage due to the high pH and consequent increases in DH or may cause issues when touching the film by hand. Such issues will limit the applicability of films made by such methods.

WO2022238244A1 relates to novel methods to manufacture composite materials comprising high levels of amyloid fibrils (preferably from 50 weight % to 80 weight %) and a polymer such as PVA. The process describes dispersing a suitable protein (preferably from a food waste material) into a PVA solution with acid, heating the acidic dispersion to cause the protein to form fibrils in-situ throughout the solution and then drying the heated acidic solution to form a film. The application mentions Whey Protein Isolate as being especially preferred due to its ability to be easily dispersed and its noted easy ability to self-assemble into fibrils when solubility is decreased by heating. WO2022238244 does mention various plant proteins as being suitable but does not teach anything about how these larger, more hydrophobic, globular plant proteins need to be treated to form fibrils in PVA.

In addition, this process would typically result in an acidic dried film. This may be suitable for some applications but will also have the same potential issues as seen for the high pH products above for insolubilising the PVA. Some PVA polymers can be insolubilised over time by low/high pHs due to increases in DH levels. This may not be an issue for some packaging applications but certainly could an issue for water-soluble packaging.

Another option is to include inert inorganic or organic materials as fillers into such PVA blends. Materials include clays, calcium carbonate, cellulosic fragments and fibres and pigments such as TiO₂. This can reduce the proportion of PVA in the blend and such blends typically demonstrate improved robustness, such as increased tensile strength, at high humidities. However, the use of such particles, especially at the high levels needed to result in a significant increase in biodegradability values, typically has a major impact on the physical properties of the film and will typically reduce the elongation potentially even to an unacceptable level, making handling and processing much more difficult.

In Polymers 2023, 15 (7), 1764, Tian et al. describe an investigation to prepare a reinforcing composite packaging film composited of soy protein/polyvinyl alcohol (PVA) and nano-TiO₂. TiO₂ is known for binding with PVA and emulsions of PVA and TiO₂ are typically latexes. TiO₂ nano-crystallites will be acting as mechanical crosslinkers of the PVA and the structural properties and behaviours of such films are largely due to the level and homogeneity of the TiO₂ in the mix and most of the study concerns methods of dispersing the TiO₂.

Thus, there remains a continuing need for films comprising PVA and plant proteins and for improved processes for forming suitable plant protein: PVA blends which can be formed into PVA-based films.

### SUMMARY OF THE INVENTION

The inventors have discovered that plant proteins, especially globular plant proteins, can be suitable materials to blend with PVA and form films having acceptable physical and stability profiles when the plant protein has been modified to improve its ability to intimately mix with the PVA.

Accordingly, in a first aspect the present invention relates to a process for forming a film comprising the steps of
(a) modifying plant protein material by
(i) reducing the d₅₀ mean particle size by volume distribution of the plant protein material to less than 30 mm, preferably less than 20 mm, more preferably less than 10 mm, and/or
   (ii) reducing the proportion of beta-sheets in the plant protein material by greater 5% as compared to the initial plant protein material;
   wherein modifying the plant protein material is carried out by milling the plant protein material;
(b) contacting the modified plant protein material with PVA and water to form an aqueous film-forming dispersion;
(c) drying the aqueous film-forming dispersion to form a film;
wherein the aqueous film-forming dispersion also comprises plasticizer.

In a further aspect the present invention also relates to a film obtainable by the process according to the invention.

In an even further aspect the present invention relates to a solid composition comprising PVA and modified plant protein material obtainable by step (a) as defined in the process according to the invention, said composition having a PVA content between 5 weight % and 95 weight % and a plant protein content between 5 weight % and 80 weight %.

The present invention also relates to a solid composition comprising PVA and modified plant protein material obtainable by step (a) as defined in the process according to the invention, wherein the composition is in the form of granules having a mean particle size of greater than 250 μm and less than 10 mm, and to a process for forming the solid composition comprising PVA and modified plant protein material obtainable by step (a) as defined in the process according to the invention, wherein the process comprises milling the plant protein material and PVA, either separately or together, and granulating the mixture to form granules.

### DETAILED DESCRIPTION OF THE INVENTION

Plant proteins, such as pea, soy, faba bean, cottonseed and canola, are typically globular proteins and have the form of spheres with the more hydrophobic protein strands wrapped around themselves. Plant proteins are typically much larger, more hydrophobic and much less soluble than most animal proteins. This makes them more difficult to process but means that the more hydrophobic plant proteins are typically less susceptible to moisture and hence could be expected to give more stable products compared to animal proteins when blended with PVA. In addition, increasing numbers of people have ethical issues with the use of animal products and there are more issues with availability of materials with animal products.

However, the form and nature of plant proteins means that simply adding a plant protein material, such as Pea Protein Isolate (PPI) or Pea Protein Concentrate (PPC), into a PVA solution, for example, and drying the resulting mixture into a film would simply result in some type of composite material formed of particles of protein embedded in a PVA matrix with all of the issues of poor physical properties seen previously in composite materials. The plant protein must be modified to make it easier to mix intimately with PVA and thus increase its ability to form suitable films. It is also necessary to be able to form these intimate mixtures and blends of PVA and modified plant protein by methods which are industrially viable. It is generally beneficial to use as much existing manufacturing equipment as possible to avoid unnecessary expense.

The invention comprises blending modified plant protein with PVA prior to film forming. The term “modified” describes plant protein that has been processed such that its structure has been modified compared to its original state so as to make it more processable and easier to mix with the PVA. A highly preferred modification is that the tightly-folded structures typical of plant proteins are at least partially denatured and unravelled.

An important requirement is that the modification of the plant protein does not involve increasing the molecular weight of the protein, as would happen with cross-linking chemistries. The modification of the protein is to make the plant protein easier to intimately mix with PVA and/or make the protein more soluble or easier to denature by the application of heat. Such modifications are incompatible with modifications that increase the molecular weight of the plant protein. The chemical modification agents specified herein are either chaotropic agents that assist in the unfolding and denaturing of the protein, such as SDS or urea, or pH adjustment materials that can cause hydrolysis of the protein and a consequent reduction in protein molecular weight. Such chemical modification agents do not result in increases in protein molecular weight, indicating an increase in unwanted structure.

The inventors have realized that “modifying” the plant protein does not have to mean that the plant protein has to be fully solubilized, as in CN104479159A. Intermediate degrees of modification, as compared to the original plant protein solid, are also suitable. Without wishing to be bound by theory, the inventors believe that retaining some level of plant protein particle structure can help provide some mechanical reinforcement to a film.

Modifying a plant protein can be done in various ways. These include biological, chemical and physical processes. Biological modification includes enzymatic treatment of the plant protein and fermentation, for example enzymatic hydrolysis using protease enzymes. Chemical modifications can include pH treatment with pH change agents, contact with chaotropic agents such as SDS, urea, and reducing agents such as sodium sulifite. Physical processes include heating, impact milling, ball-milling, high pressure processing such as high-pressure homogenization and treatments with EM radiation. Different modification processes can be combined.

The structures and conformations that proteins can adopt can be described by various primary, secondary and tertiary structures. The primary structure of a protein is the peptide sequence forming the primary strand. The secondary structure describes the various ways that peptide strands can interact with themselves and with neighbouring strands. The tertiary structure describes how the protein is folded overall. On top of the tertiary structure will be any macro-structure—for example larger particles formed by the processing of the protein, such as precipitation or spray-drying. Often these structures are formed during the extraction or purification of the protein from its original source. The most important secondary structures in proteins are beta-sheets, and more amorphous forms such as alpha-helices, beta turns and random turns.

The structure of any plant protein particle or material needs to be in a form which is able to mix intimately—or at least avoid negative interactions—with PVA if the blend is to form a robust film. Modified plant proteins are proteins which have been modified to have one or more of their secondary, tertiary and macro-structures modified or changed compared to the original material using the possible methods described previously. The original forms and structures of globular plant proteins inherently limit the ability of the plant protein to mix intimately with a polymeric material like PVA. Multiple different modifications to the secondary, tertiary and macro-structures of globular plant proteins can enhance the ability of a plant protein to be mixed together with PVA in a more intimate manner before being dried to form a film. These beneficial modifications do not result in an increase in protein molecular weight.

Reducing the particle size of a plant protein material by intense shearing or impact events (generally referred to as “milling”) is a way of modifying plant protein materials to make them better able to mix intimately with PVA—or indeed any suitable polymer—in a solution or in a thermoplastic mix. Reducing the d₅₀ mean particle size by volume distribution of the plant protein to less than 30 microns, or even less than 20 microns or most preferably less than 10 microns is one means to modify the plant protein material.

Milling the plant protein material can also change the shape of any protein particles and the chemical nature of the external exposed surfaces of the milled plant protein. Milling of globular plant proteins can expose parts of the protein that would normally be more hidden in the core of the globular protein. Milling a globular plant protein will also increase the external surface area of the protein material which will also inherently increase the ability of the protein to interact in some manner with the PVA (or other) polymer. This results in modification of the plant protein secondary structure as measured herein by FTIR. Reducing the beta-sheets level by greater than 5% as compared to the initial plant protein material is another means to modify the plant protein material.

In accordance with the present invention milling can be carried out in one or more separate stages. Typically, when the milling is done in separate stages the milling conditions will be varied between the different stages, for example by changing equipment or equipment operation parameters.

This can be achieved, for example, by passing an aqueous dispersion of plant protein solid material, such as pea protein concentrate or pea protein isolate, through equipment such as a sonicator, high-pressure homogenizer or mixed media mill. Alternatively the plant protein material such as a protein concentrate, isolate or other protein-rich solid can be milled as a solid, for example in an impact mill such as a ball mill or jet mill. Such processing will reduce the particle size of the plant protein (changing the macro-structure) and can also be used, with increasing levels of intensity, to alter the tertiary and even the secondary structure of the plant protein.

Equipment such as a high-pressure homogenize reduces the particle size of the plant protein materials by the application of very intense shear. Mixing or stirring mixtures, e.g., by an impeller, would not reduce the size of any plant protein material particles present.

Such treatment can be carried out in combination with chemical and/or thermal treatments. For example, the aqueous plant protein dispersion can also contain chemical modification agents, such as chaotropic agents such as SDS surfactant or urea, reduction agents such as sodium sulfite or pH treatment agents such as sodium hydroxide. In one preferred embodiment, the aqueous dispersion can also contain a low level of an organic acid, preferably acetic acid or lactic acid. The inventors have observed that the presence of a low level of such acids in the aqueous dispersion can help in the (typically partial) unfolding of the proteins by acting as a solvent for the protein, especially in combination with temperature and/or shear. In one embodiment the organic acid is preferably acetic acid or lactic acid. There can be advantages in using an organic acid that is volatile enough to be removed from the film during drying for reasons described herein.

A preferred embodiment is to form a modified plant protein dispersion by passing an aqueous dispersion of plant protein material (between 10 weight % and 20 weight %) and organic acid (2 weight % to 8 weight %) through a high-pressure homogenizer. A further preferred embodiment is that the temperature of the dispersion is maintained at less than 50° C. during processing and afterwards. The modified plant protein dispersion can then be added to PVA (either as a solid or in solution) with mixing and dried to form a film.

The plant protein material can be milled as an aqueous dispersion and then mixed with dissolved PVA prior to being formed into a film. Another embodiment is to add powdered PVA to the modified, milled protein emulsion and agitate to dissolve the PVA. Alternatively, the aqueous dispersion can also comprise PVA during milling. The aqueous dispersion will typically also contain plasticisers such as glycerol before being formed into a film. The plasticisers can be included into the final PVA: protein dispersion at different stages of the process. A preferred embodiment is that the aqueous plant protein: PVA dispersion contains plasticisers added through mixing with a Silverson mixer before it is subjected to a high intensity shear step.

The plant protein material can be modified as a solid or modified as an aqueous dispersion or modified as an aqueous dispersion and then formed into a solid. Modifying the plant protein as a solid or by forming modified plant protein into a solid, for example by spray-drying, can have advantages in reducing the amounts of material needing to be transported. Solid modified plant protein material will then have to be contacted with water to form a dispersion prior to film forming.

Plant-based proteins are mainly comprised of globular proteins which are storage proteins and can be classified as albumins (soluble in water), globulins (soluble in dilute salt solutions), prolamins (soluble in aqueous ethanol solutions), and glutelins (soluble in dilute acid/alkaline solutions or insoluble in water).

Albumins and globulins are predominately present in all pulses (at greater than 50%) and some pseudo cereals (such as quinoa and amaranth). Globulins represent between about 70 and 78 wt % of the protein found in legume seeds, whereas albumins constitute between about 10 and 20 wt % of the protein. Globulins are the storage proteins of most legume seeds. Globulins have higher molecular weights than albumins and are insoluble in pure water but dissolve in dilute salt solutions. Globulins are typically more water soluble than prolamins.

In typical commercial protein isolates, there are generally only residual amounts of albumins present as they are generally removed during the protein extraction process.

Globulins are typically obtained from soybean, pea, rice, potato, rapeseed, sunflower, cottonseed, lentil, chickpea, bean, fava bean, mung bean, sunflower seed, pumpkin seed, flax, chia, canola, lupine, alfalfa, moringa, borage, hemp seed, and cotton seed; preferably obtained from pea protein, potato protein, rapeseed protein, cottonseed protein and/or sunflower protein.

Prolamins and glutelins make up 85% of protein in the cereal and pseudo cereal families. Prolamins are typically found in wheat, corn, barley and rye whilst glutelins are typically only found in wheat and rice.

Prolamins are high in proline and glutamine amino acid content. They have a relatively high fraction of non-polar functionalities. They are less abundant than globulins and are found across fewer plant species. They include gliadin from wheat, hordein from barley, secalin from rye, zein (alpha, beta, gamma) from corn, kafirin from sorghum, avenin from oats. Prolamins are typically much less water soluble than Globulins.

Rubisco protein, Ribulose bisphosphate carboxylase/oxygenase, is the most abundant plant protein found in every green leaf. It is the key enzyme in photosynthesis responsible for the fixing carbon dioxide from the atmosphere. Rubisco is a globular protein with very specific functionality and is significantly different from plant storage proteins, in particular significantly different to globulin proteins. There is growing interest in commercialising it and extracting it from agricultural waste streams for its nutritional and functional properties. It has been shown to be extracted from leaves of sugar beet, mulberry, alfalfa, aubergine, radish, duckweed and other vegetable byproducts.

In a preferred aspect of the present invention, the plant protein material comprises one or more plant proteins selected from albumin and globulin proteins, most preferably globulin proteins.

In a preferred aspect of the present invention, the plant protein material comprises one or more plant proteins which have been extracted from the natural plant material, such as seeds, leaves, roots or other plant organs, and purified to increase the protein content.

In another preferred aspect of the present invention, the plant protein material comprises one or more plant proteins which remain in the natural plant material without having been extracted from the seeds, leaves, roots or other plant organs.

In a preferred aspect of the present invention, the plant protein material comprises one or more plant-based proteins selected from the group consisting of soybean protein, pea protein, rice protein, potato protein, rapeseed protein, cottonseed protein, lentil protein, chickpea protein, bean protein, fava bean protein, mung bean protein, sunflower seed protein, pumpkin seed protein, flax protein, chia protein, canola protein, lupine protein, alfalfa protein, moringa protein, borage protein, hemp seed protein and cotton seed protein, preferably selected from pea protein, potato protein, rapeseed protein, and/or sunflower protein. Most preferably, the plant protein material comprises one or more plant-based proteins selected from pea protein, rapeseed protein, bean protein, soy protein and sunflower protein.

Suitable plant protein sources include soybean, pea, rice, potato, rapeseed, sunflower, cottonseed, lentil, chickpea, bean, fava bean, mung bean, pumpkin seed, flax, chia, canola, lupine, alfalfa, moringa, borage, hemp seed. A preferred embodiment for modifying plant protein is to grind or mill plant protein materials. Such plant protein materials can include protein isolates, such as Pea, Cottonseed, Canola, Potato or Soy Protein Isolates. Typically, such isolates have protein levels above 70 weight %. The plant protein materials can also include materials having a lower protein level, such as concentrates having typical protein levels of 50-60 weight % or lower, such as 20-50 weight %. Various sources of plant proteins, such as waste materials from vegetable oil extraction, can be used. A preferred process is to combine and integrate protein modification into any protein extraction process. Many materials will also contain starches and fibrous cellulosic materials. Grinding or milling of such materials can be very advantageous to increase the ability of such materials to intimately mix with PVA when in aqueous dispersion.

The plant protein material can be milled on its own or can be co-milled with chemical treatment agents. A preferred embodiment is for the plant protein material to be milled as a solid powder. It can also be co-milled with PVA solid. Co-milling a mixture of powder materials may be used to produce a powder blend that is easier to disperse into water and form an aqueous dispersion for film forming. Note that powdered materials may still contain some level of water or solvent. The fact that the material is in powder form, that it is solids, does not mean that it has to be completely dry.

Suitable equipment for milling plant protein material in accordance with the present invention includes impact mills such as pin mills, attrition mills, air jet mills and agitated media mills. Agitated media mills further comprise tumbling and/or vibrating ball and rod mills, planetary ball mills and stirred media mills. The term “media mill” includes both bead and ball mills, as the only real difference relates to the size of the grinding balls.

A further preferred embodiment is for the plant protein material to be milled as an aqueous dispersion, preferably using a stirred media mill or a high-pressure homogeniser. The milled plant protein material can then be contacted with PVA, either in solid or solution form. The plant protein material can also be milled in the presence of at least part of the PVA. This could include milling plant protein material dispersed in a PVA solution or milling both solid plant protein and PVA in water. In this case, the milling of solid PVA accelerates its dissolution.

A preferred embodiment is to use ball mills when co-milling the plant protein with chemical modification agents, due to the time required for chemical interactions to take place. Co-milling can be done simultaneously or sequentially—for example the plant protein material could be milled by itself to form a milled material, then a chemical modification agent could be added to the milled material and milled further and then solid PVA could be added to the mix and milled. The order of milling is not typically limiting.

Such co-milling of materials can simplify commercial production and can also result in solid materials that are more easily transported and dispersed into water. For example, many water-soluble polymers such as PVA can be hard to disperse into water due to their tendency to gel during the dissolution process. Co-milling solid polymer with a material like a plant protein can offer advantages as the protein can coat the polymer particles and slow down water ingress such that dispersion is improved.

A further preferred embodiment is to granulate the resulting milled material or mixes, for example with steam or water or an aqueous solution of a binder such as SDS surfactant or sugar, so as to form a solid composition of larger, porous granules. Such granules, also commonly referred to as agglomerates, can be easier to handle and to disperse in water when forming the dispersion for casting into a film. Suitable compositions can have PVA: plant protein ratios from 5:95 to 95:5. Such mixtures will also typically contain other plant-based materials, such as starches or cellulosic materials. Suitable equipment could include an Eirich granulator or a pan granulator. Pan granulation may be preferred due to the porous nature of the resulting granules. Such granules will typically have a bulk density of less than 500 g/l due to the porosity of the granules. Lower bulk densities indicate more porous granules which will be easier to disperse in water. Such granules typically have mean particle sizes of greater than 250 μm and less than 10 mm. Chemical modification agents can be included in the milled blends at levels of up to 30% of the weight of the protein on a dry solids basis.

The use of such dispersions, whether formed by dispersed powder blends into water and plasticiser, or blending protein dispersions with PVA solutions, or variants and combinations of these, can be used to give more concentrated plant protein: PVA blends which are easier to form into films due to the reduced drying requirement compared to the dilute systems typically disclosed in the art.

As mentioned above, changing the secondary, tertiary or macro structure of the plant protein before or during formation of the film-forming dispersion can make the plant protein more suitable for intimate mixing with the PVA. This can be achieved by the various modification techniques mentioned previously, either independently or in combination.

Protein secondary structures have a variety of forms, such as beta-sheets, alpha-helices, beta-turns and other amorphous forms. Beta-sheets are formed by peptide strands aligning together and hydrogen bonding to form planar structures. These are robust structures—for example beta-sheets give silk its strength. There are two beta-sheet forms that are important. “Intermolecular” beta-sheets are beta-sheets formed between two different protein molecules. “Intramolecular” beta-sheets are formed by peptide strands within the same folded protein molecule. Since beta-sheets are associated with folded protein structures which will limit intimate mixing with PVA, modifications that reduce the proportion of beta-sheets in the plant protein dispersion (in relation to the initial plant protein material) being added to the PVA solution are beneficial. The inventors have seen that plant protein material that has been processed into modified plant protein material in accordance with the present invention may have a reduced level of beta-sheets, wherein the reduction due to processing is greater than 5% and preferably greater than 10%. Such modified plant protein material is suitable for incorporation into PVA-containing films. Additionally, a chemical or biological modification agent such as SDS, urea, organic acids, inorganic acids, alkalis and enzymes may be added to the plant protein material and assist in the reduction of beta-sheets.

An aqueous dispersion of the milled plant protein material could be contacted with protease enzyme with stirring prior to contact with the PVA. Alternatively, enzymatically treated plant protein can be used as the plant protein material.

The modified plant protein material dispersions can be dried, for example by spray-drying, prior to being contacted with the PVA. The dried modified plant protein dispersion can be pre-mixed with PVA powder prior to the mixture being dissolved or could be added to a PVA

### Solution

Modification of the plant protein can happen before the plant protein is contacted with the PVA or can happen when the plant protein has been contacted with the PVA. The plant protein can be an aqueous dispersion or a solid when contacted with the PVA and the PVA can be a solution or solid when contacted with the plant protein. The end result of contacting the modified plant protein with the PVA is an aqueous dispersion or a solid mixture comprising modified plant protein, PVA and plasticisers suitable for film forming by solution casting or extrusion processing. Suitable processes and equipment are known in the art.

The aqueous film-forming dispersions of modified plant protein material and PVA in accordance with the present invention are suitable for forming into films or coatings. Within the meaning of the present invention “films” comprise “coatings”, since coatings are nothing else than films attached to and dried onto a substrate such as mylar or card or paper. The total level of plant protein and PVA in the films or coatings is preferably greater than 50 wt % or preferably greater than 60 wt %, or preferably greater than 70 wt %. The films or coatings also typically include water and plasticisers.

Typically, the level of PVA in the final film or coating is greater than 20 wt %, greater than 30 wt %, greater than 40 wt %, or even greater than 50 wt %. Typically, the level of PVA in the final film or coating is less than 90 wt %, or less than 80 wt %.

Typically, the level of modified plant protein in the final film or coating is greater than 5 wt %, greater than 10 wt %, greater than 20 wt %, greater than 40 wt %, or even greater than 50 wt %. The level of modified plant protein in the final film or coating is typically less than 90 wt %, less than 80 wt %, or even less than 70 wt %.

The final film or coating will also typically contain plasticiser as well as water. Levels of plasticiser will typically be between 5 wt % and 40 wt % of the film or coating.

The level of water will partially depend on the external environmental conditions but will typically be between 2 wt % and 20 wt % of the film or coating.

The final film or coating may also contain preservatives, rheology or structural modifiiers such as cellulose fibres, other processing aids, and/or pH adjusting agents.

Plasticiser for films are well known in the art and preferred plasticisers are selected from the group consisting of glycerol, propylene glycol, polyethylene glycol, sorbitol, erythritol, mannitol, xylitol, triethyl citrate, monoglycerides, diglycerides, triglycerides, glucose, mannose, fructose, sucrose, urea, lecithin, waxes, and amino acids and mixtures thereof. Preferably, the plasticisers are bio-based and even more preferably plant-derived.

Plasticisers can also be added in the form of a mixture with other components, preferably a bio-based and even more preferably a plant-derived mixture.

The aqueous film-forming dispersions of modified plant protein material and PVA in accordance with the present invention can be formed into films by solution casting processes, as known in the art. It is also possible to form films, or other formed bodies such as extrudates, by melt-extrusion. Such film-forming dispersions of modified plant protein material and PVA in accordance with the present invention will typically comprise the blends of modified plant protein material and PVA in combination with plasticisers and a low level of water.

PVA can have a wide range of molecular weights and chemical modifications. High molecular weight (MW) PVA typically gives more robust films. For example, higher MW PVA (having a MW between 30,000 and 70,000) could be used in combination with a modified plant protein to improve the properties of the resulting film. A further preferred embodiment is that the PVA is compatible with the nature of the modification of the plant protein. For example, if the plant protein has been modified by high pH treatment and retains a high pH either in aqueous or solid form, it is preferable for the PVA to be selected from a high-pH resistant grade. Typically, such PVA polymers are modified with additives, such as side chains, to reduce crystallinity.

### BRIEF DESCRIPTION OF THE FIGURES

FIG. 1: 2^{nd} derivative normalized for pea protein isolate samples as measured by FTIR

FIG. 2: % of protein structures in pea protein isolate samples as measured by FTIR

FIG. 3: normalized FTIR spectrum for soy protein isolate samples

FIG. 4: 2^{nd} derivative normalized for soy protein isolate samples as measured by FTIR

FIG. 5: % of protein structures in soy protein isolate samples as measured by FTIR

FIG. 6a: Film resulting from Inventive Example 7a

FIG. 6b: Film resulting from Inventive Example 7b

FIG. 7: Film resulting from Comparative Example 7c

### EXAMPLES

### Test Methods

### Measurement of Particle Size

The particle size needs to be measured by different ways depending on the form of the material.

The particle size of milled protein particles is typically measured by laser diffraction. A suitable standard for size analysis by laser diffraction is given in ISO 13320:2009. Suitable size analysers include the Mastersizer 3000 by Malvern Instruments and the Anton Paar Particle Size Analyser PSA 1190.

For dry milled protein material the sample to be tested is dispersed in isopropanol. A concentration of 0.1 g solid material in 100 mL of isopropanol is suitable and the sample should be dispersed by application of ultrasound for 30-60 seconds.

For wet milled protein material the sample is measured as is or suitably diluted in the same liquid medium, for example neutral pH reverse osmosis water.

The measurement is typically done as per the manufacturer's instruction manual and test procedures. Typically all measurements were done in triplicate, and the averages are quoted herein. Particle size d₅₀ quoted is for the volume distribution. d₁₀ and d₅ values for the volume distribution can also be obtained in this way using laser diffraction.

The particle size of individual particles forming larger agglomerates can be measured by image analysis of gently crushed agglomerates. Gently crushing the granules exposes internal surfaces for analysis. The particle sizes of individual particles can be measured by optical analysis, using software such as ImageJ. At least 50 separate measurements of particles need to be taken to determine the mean particle size of the particles forming the larger granule.

The particle size of larger agglomerates can be determined by sieving. A sample of the agglomerates, for example 30 g, is added to a stack of sieves of increasing mesh gap sizes and the stack vibrated for a set period of time. The average particle size is then calculated form the fractions on the different sieve sizes.

### Protein Structural Determination

Data on beta-sheet and other structural forms can be determined by Fourier Transform Infrared (FTIR) techniques. Suitable spectrometers include the Thermo-Fisher Nicolet iS10, the Bruker Equinox 55/S FTIR spectrometer the JASCO FT/IR 6200 and the Cary 630 (Agilent) FTIR spectrometer. The Bruker spectrometer is preferred due to its greater sensitivity sensitivity as a function of spectral resolution and signal-to-noise ratio. Secondary structural components including random coils, α-helices, intermolecular (parallel and antiparallel) β-sheets, intramolecular β-sheets and β-turns were evaluated using Fourier self-deconvolution of the infrared absorbance spectra. Background measurements were taken on an empty cell and the background was subtracted from the reading of samples.

Data was collected using 128 or 256 scans (depending on the equipment) at 4 cm⁻¹ resolution with background subtractions. For the structural analysis of proteins, the original data was smoothed applying a Savitzky-Golay filter (for example 2nd order, 9 points with the Bruker spectrometer) and the second derivative was calculated applying a Savitzky-Golay filter (for example 2nd order, 15 points with the Bruker spectrometer) and normalized.

The second derivative in the Amide I band (1600-1700 cm⁻¹) was calculated from the smoothed data to deconvolve and quantify the secondary and quaternary structural contributions using the peaks at different wavelengths. The peaks were allocated to the various structures according to the following wavelengths:

| Parallel | Anti-parallel | | | |
|---|---|---|---|---|
| Intermolecular | intermolecular | Intramolecular | Alpha helix + | |
| beta-sheets | beta-sheets | beta-sheets | Random Coil | Beta-Turn |
| 1618-1622 cm⁻¹ | 1692-1696 cm⁻¹ | 1628-1632 cm⁻¹ | 1648-1652 cm⁻¹ | 1668-1672 and |
| | | | | 1678-1682 cm⁻¹ |

The percentage of each structure relative to all the structures was calculated from the peak areas. Intermolecular beta-sheet levels are the combination of parallel and anti-parallel intermolecular beta-sheet levels.

Beta-sheet levels are a combination of the intermolecular and intramolecular beta-sheets.

Typically, all measurements were done in triplicate, and the averages are quoted herein.

### Measurement of Normalised Heat Flow and Onset Melting Temperature by Differential Scanning Calorimetry

Differential Scanning calorimetry can be used to determine whether the plant protein has been chemically crossed linked during processing.

Suitable Differential Scanning calorimetry equipment includes the DSC882e from Mettler-Toledo. A small sample (10-30 mg) of the material being tested is placed in an aluminium pan such as a 40 μL aluminium pans (#51119870, purchased from Mettler Toledo), and heated from 25° C. to 180° C. at a heating rate of 10° C./min in a nitrogen atmosphere. The pan lid should be pierced prior to the sealing and an empty pan used as a reference. The normalised heat flow is recorded and plotted as a function of temperature.

The onset melting point of a sample is defined as the first inflection point in the DSC curve showing a rate increase in the heat flow to the sample with increasing temperature. As the sample starts to melt, the heat flow to the sample increases, thus creating a change of gradient and an inflection point in the graph.

Normalised heat flow plots can be visually assessed by an operator to determine the inflection point in the graph. However, this analysis is now typically done using software analysis tools. Such analysis tools are typically included as part of the equipment operating system. Suitable software includes the STARe evaluation software supplied by Mettler-Toledo.

### Materials

ProEarth Pea Protein Isolate (80% protein) was sourced from Cambridge Commodities

Soy Protein Isolate (90.8% protein) was sourced from Biomedicals LLC

Pea Protein Concentrate (typically 55% protein) from AGT Foods

Sodium hydroxide pellets (98.5% lab grade) were sourced from ThermoScientific

PVA crystals Mowiol® 4-88 (molecular weight approximately 31000) were sourced from Sigma-Aldrich, UK

Isopropanol was sourced from Fisher Scientific, UK

Water used was lab-grade Reverse Osmosis water.

Urea (Technical Grade) was sourced from VWR International.

Sodium Dodecyl Surfactant (SDS) 99% was sourced from VWR International.

Tapioca starch was sourced from the Bakerite Company, UK.

### Example 1

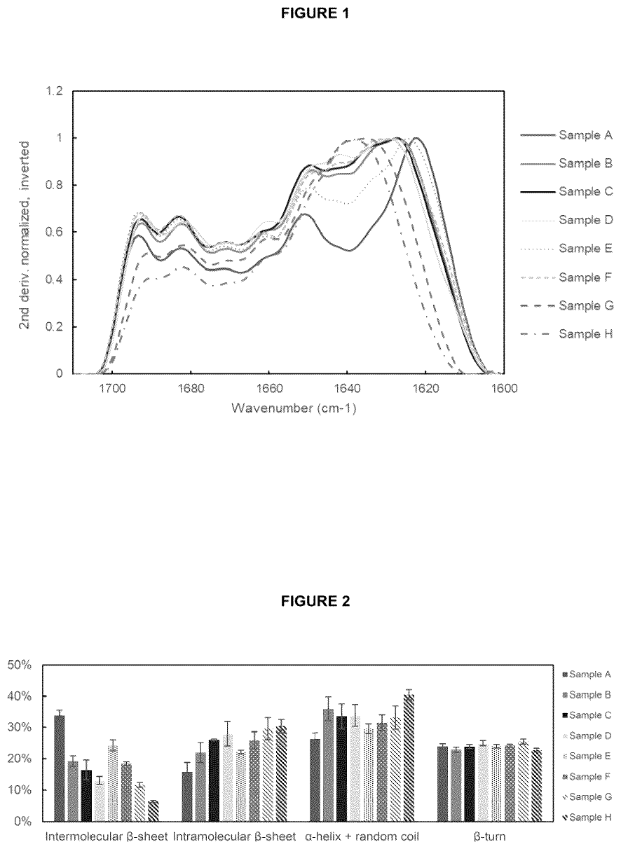

Commercially available Pea protein isolate (PPI), with no milling, was measured by laser diffraction (using an Anton Par PSA 1190) to have a d₅₀ particle size of 68.2 microns. FTIR analysis was carried out according to the method herein using a Bruker spectrometer and the spectrum, 2^{nd} derivative (FIG. 1) and % of secondary structures was obtained (FIG. 2). FTIR analysis showed it to have an intermolecular beta-sheet level of 33.8%, an intramolecular beta-sheet level of 15.8% (Sample A). The total level of beta-sheets was therefore 49.6%.

Commercially available Pea protein concentrate (PPC), with no milling, had a particle size of less than 150 microns. FTIR analysis was carried out according to the method herein using a Bruker spectrometer and the spectrum, 2^{nd} derivative and % of secondary structures was obtained. FTIR analysis showed it to have an intermolecular beta-sheet level of 9.6%, an intramolecular beta-sheet level of 45.9% (Sample J). The total level of beta-sheets was therefore 55.5%.

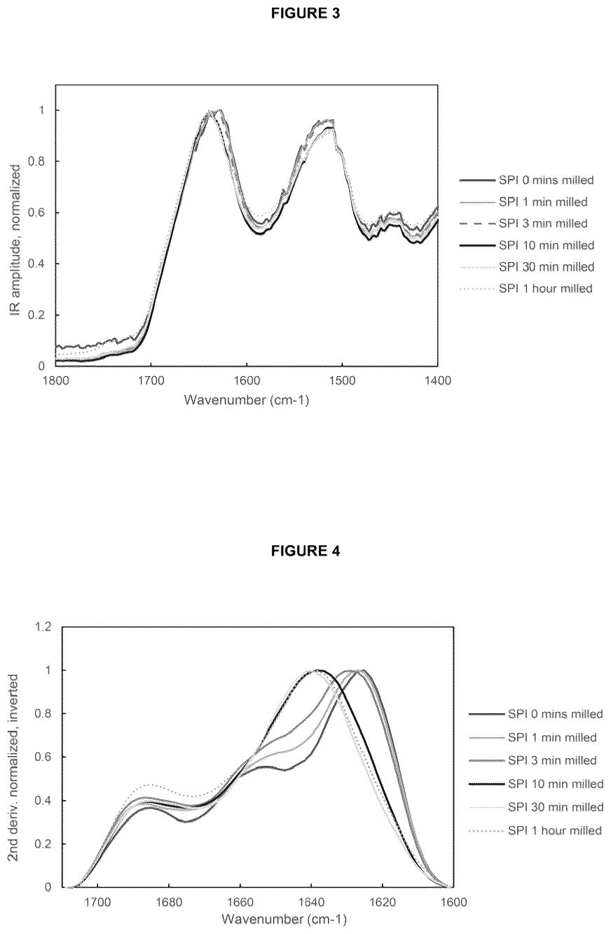

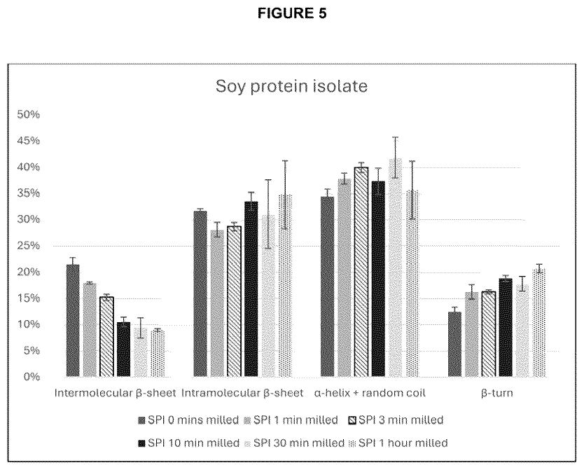

Commercially available Soy protein isolate (SPI) with no milling, had its particle size measured by laser diffraction (using an Anton Par PSA 1190) and found to have a d₅₀ of 40.9 microns. FTIR analysis was carried out according to the method herein using a Cary 630. Due to the reduced sensitivity of this equipment smoothing was done with 22 points for the original spectrum and 34 points for the 2^{nd} derivative. The spectrum, 2^{nd} derivative and % of secondary structures are shown in FIGS. 3, 4 and 5 respectively. Sample L with no milling was found to have an intermolecular beta-sheet level of 21.5%, an intramolecular beta-sheet level of 31.6% (Sample L). The total level of beta-sheets was therefore 53.1%

### Example 2

Commercially available Pea protein isolate, PPI, (Sample A) underwent modification by mechanical action by milling. The particle size was measured by laser diffraction (using an Anton Par PSA 1190) and FTIR analysis was carried out according to the method herein using a Bruker spectrometer and the spectrum, 2^{nd} derivative (FIG. 1) and % of secondary structures (FIG. 2) was obtained.

Samples A, B, C and D were prepared by milling in a Retsch MM 400 lab tumbling ball mill at 20 Hz and 30 Hz using a custom-made stainless steel jar (approximately 40 mls) filled with three 12 mm diameter stainless steel balls.

Samples E and F were prepared by milling 7.2 g of commercial PPI in a Retsch PM100 lab planetary ball mill for at 450 rpm using 5 mm diameter ZrO2 balls with pauses every 10 mins to allow the heat generated to dissipate.

The results are given in Table 1. All the milled samples had an overall greater than 5% reduction in beta-sheets. For those samples where the post-milling particle size was measured it was found that the d50 was below 30 microns.

TABLE 1
PSD and % beta-sheets levels of PPI

| | | PSD | Inter | Intra | | % beta-sheets |
|---|---|---|---|---|---|---|
| PPI | | d50 (vol) | molecular | molecular | Total | change with |
| sample | Ball mill | (microns) | beta-sheets | beta-sheets | beta-sheets | milling |
| Sample A | No milling | 68.2 | 33.8 | 15.8 | 49.6 | n/a |
| Sample B | Tumbling 30 Hz 10 min | 16.6 | 19.2 | 22.0 | 41.2 | 16.9 |
| Sample C | Tumbling 20 Hz 2 hours | n/a | 16.5 | 26.1 | 42.6 | 14.1 |
| Sample D | Tumbling 30 Hz 30 min | 25.0 | 13.1 | 28.0 | 41.1 | 17.1 |
| Sample E | Planetary 450 rpm 30 mins | n/a | 24.3 | 22.1 | 46.4 | 6.5 |
| Sample F | Planetary 450 rpm 2 hrs | 23.3 | 18.4 | 25.9 | 44.3 | 10.7 |

### Example 3

The commercially available PPI (Sample A) was milled with 7% solid NaOH in a Retsch MM400 tumbling ball mill using a custom made stainless steel jar (approximately 40 mls) filled with three 12 mm diameter stainless steel ball at 30 Hz.

The particle size was measured by laser diffraction (using an Anton Par PSA 1190) and FTIR analysis was carried out according to the method herein using a Bruker spectrometer and the spectrum, 2^{nd} derivative (FIG. 1) and % of secondary structures (FIG. 2) was obtained.

The results are given in Table 2. All the milled samples had an overall greater than 5% reduction in beta-sheets.

TABLE 2
PSD and % beta-sheets levels for plant protein and additive co-milling

| | MM400 | PSD | Inter | Intra | | % beta-sheets |
|---|---|---|---|---|---|---|
| | Tumbling | d50 (vol) | molecular | molecular | Total | change with |
| PPI | ball mill | (microns) | beta-sheets | beta-sheets | beta-sheets | milling |
| Sample A | No milling | 68.2 | 33.8 | 15.8 | 49.6 | n/a |
| Sample G | 30 Hz 30 mins | n/a | 11.7 | 29.6 | 41.3 | 16.7 |
| Sample H | 30 Hz 2 hrs | n/a | 6.4 | 30.4 | 36.8 | 25.8 |

### Example 4

Commercially available Pea protein concentrate, PPC, (Sample J) underwent modification by mechanical action by milling. The particle size was measured by laser diffraction (using an Anton Par PSA 1190) and FTIR analysis was carried out according to the method herein using a Bruker spectrometer and the spectrum, 2^{nd} derivative and % of secondary structures was obtained.

The sample was milled in a Retsch MM 400 lab tumbling ball mill at 20 Hz and 30 Hz using a custom-made stainless steel jar (approximately 40 mls) filled with three 12 mm diameter stainless steel balls.

The results are given in Table 3. The milled sample had an overall greater than 5% reduction in beta-sheets and a post-milling particle size d50 below 30 microns.

TABLE 3
PSD and % beta-sheets levels of PPC

| | | PSD | Inter | Intra | | % beta-sheets |
|---|---|---|---|---|---|---|
| PPC | | d50 (vol) | molecular | molecular | Total | change with |
| sample | Ball mill | (microns) | beta-sheets | beta-sheets | beta-sheets | milling |
| Sample J | No milling | n/a | 9.6 | 45.9 | 55.5 | n/a |
| Sample K | Tumbling 30 Hz 10 min | 17.4 | 8.7 | 39.5 | 48.2 | 13.2 |

### Example 5

Commercially available Soy protein isolate (SPI) (Sample L) underwent modification by mechanical action by ball milling in a Retsch MM 400 lab tumbling ball mill at 30 Hz for between 1 minute and 1 hour using a custom-made stainless steel jar (approximately 40 mls) filled with three 12 mm diameter stainless steel balls. The particle size was measured using an Anton Par PSA 1190 (in triplicate). FTIR analysis was carried out according to the method herein using a Cary 630 as described in the methods section. The FTIR spectrum, 2^{nd} derivative and % of secondary structures are shown in FIGS. 3, 4 and 5 respectively.

All the milled samples had an overall greater than 5% reduction in beta-sheets and a particle size d50 below 30 microns. Some results are given in Table 4.

TABLE 4
PSD and % beta-sheets levels of SPI samples

| | MM400 | PSD | Inter | Intra | | % beta-sheets |
|---|---|---|---|---|---|---|
| | Tumbling | d50 (vol) | molecular | molecular | Total | change with |
| SPI sample | ball mill | (microns) | beta-sheets | beta-sheets | beta-sheets | milling |
| Sample L | No milling | 40.9 | 21.5 | 31.6 | 53.1 | n/a |
| Sample M | 30 Hz 10 mins | 18.5 | 10.5 | 33.5 | 43.9 | 17.4 |
| Sample N | 30 Hz 1 hr | 25.5 | 8.9 | 34.8 | 43.7 | 17.8 |

### Example 6

3720 g of the same PPI batch as used in earlier examples was mixed with 280 g of crushed NaOH pellets and loaded into a rotating drum of length 0.8 m and diameter 0.75 m. The drum was loaded with 10 kg of ceramic grinding balls having a diameter of 3.5 cm and then rotated at 37 rpm for 7 hours. The post-ball milled material had a d₅₀ particle size of 25.6 microns.

Another 4 kg batches were co-milled using the larger drum as above, under similar conditions. The following compositions were prepared on a weight basis:

| | |
|---|---|
| Batch 1 | 96.5% PPI, 3.5% NaOH |
| Batch 2 | 92.5% PPI, 3.5% NaOH, 4% SDS |
| Batch 3 | 92% PPI, 4% urea, 4% SDS |
| Batch 4 | 68.5% PPI, 20% tapioca starch, 3.5% NaOH, 4% SDS, 4% urea |

All samples had d₅₀ particle sizes between 23 microns and 27 microns when measured using a Mastersizer 3000 according to the described method.

### Inventive Examples 7a and 7b

PPI powder was ball milled according to Example 1 Sample B.

An aqueous film-forming dispersion of composition 6.8 wt % PPI solids, 2.9 wt % PVA, 5.3 wt % glycerol, 85 wt % water PVA was prepared in two different ways.

In the first process the PVA was dissolved in water at room temperature. The ball milled PPI was added to the solution of PVA together with glycerol at room temperature and mixed with a speed mixer at 1500 rpm for 30 seconds, followed by 1950 rpm for 2 minutes and then 1500 rpm for 30 seconds to form Dispersion 7a.

In a second process the PVA was dissolved in water at 90° C. and then allowed to cool to room temperature. The ball milled PPI was added to the solution of PVA together with glycerol at room temperature and mixed with a Silverson at 3000 rpm for 1 minute. The dispersion was then passed through a lab High Pressure Homogeniser (Homogenising Systems Pressure Cell Homogeniser SPCH-EP model FPG12805) at 100 MPa to form Dispersion 7b.

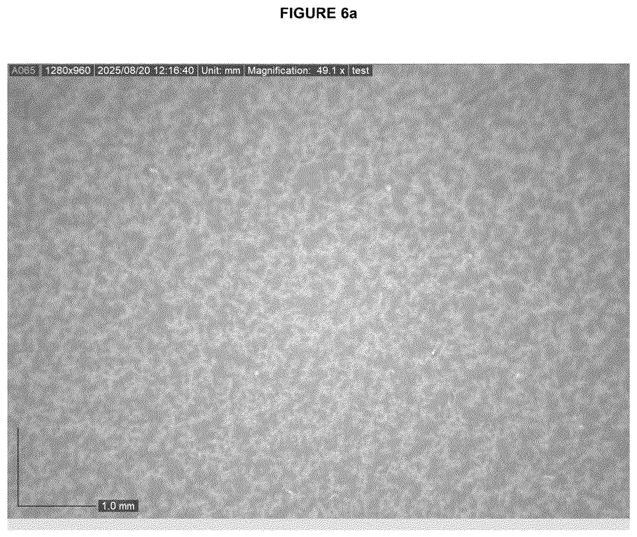

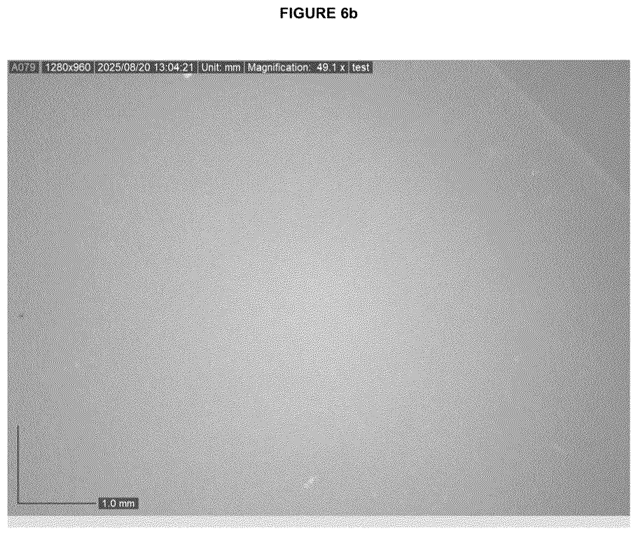

The dispersions were stored at 4° C. overnight before casting onto Mylar with a 300 micron wet thickness K-bar. The dispersions were left to dry in an oven around 80° C. for approximately 30 minutes to form a Film 7a and Film 7b respectively. As can be seen in the photograph of FIG. 6a Film 7a has a uniform structure from the intimate mixing of the modified plant protein and PVA. In FIG. 6b Film 7b has a uniform structure which is even finer than that of Film 7a.

### Comparative Example 7c

PVA was dissolved in water at room temperature. The unmilled PPI was added to the solution of PVA together with glycerol at room temperature and mixed with a speed mixer at 1500 rpm for 30 seconds, followed by 1950 rpm for 2 minutes and then 1500 rpm for 30 seconds to form an aqueous film-forming Dispersion 7c of composition 6.8 wt % PPI solids, 2.9 wt % PVA, 5.3 wt % glycerol, 85 wt % water.

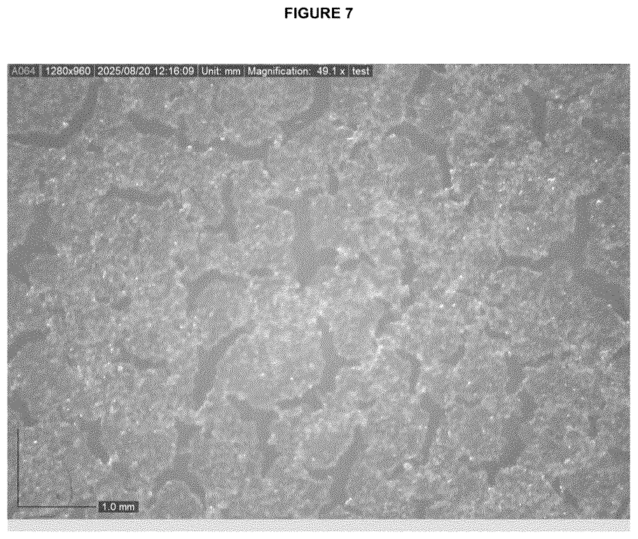

The dispersion was stored at 4° C. overnight before casting onto Mylar with a 300 micron wet thickness K-bar. The dispersion was left to dry in an oven at 80° C. for approximately 30 minutes to form a Film 7c. As can be seen in the photograph of FIG. 7 Film 7c has a non-uniform structure due to the poor mixing of the unmodified plant protein and PVA.

1. A process for forming a film comprising the steps of
(a) modifying plant protein material by
(i) reducing the d₅₀ mean particle size by volume distribution of the plant protein material to less than 30 mm, preferably less than 20 mm, more preferably less than 10 mm, and/or
(ii) reducing the proportion of beta-sheets in the plant protein material by greater 5% as compared to the initial plant protein material;
wherein modifying the plant protein material is carried out by milling the plant protein material;
(b) contacting the modified plant protein material with PVA and water to form an aqueous film-forming dispersion;
(c) drying the aqueous film-forming dispersion to form a film;
wherein the aqueous film-forming dispersion also comprises plasticizer.

2. A process according to claim 1, wherein modifying the plant protein material is further carried out by contacting the plant protein material with one or more chemical or biological modification agents selected from SDS, urea, organic acids, inorganic acids, alkalis and enzymes.

3. A process according to claim 2, wherein both milling the plant protein material and contacting the plant protein material with one or more chemical or biological modification agents are either carried out simultaneously or sequentially, preferably wherein contacting the plant protein material with one or more chemical or biological modification agents is carried out before milling the plant protein material.

4. A process according to claim 1, wherein (a) is carried out with the plant protein material as a solid or as an aqueous dispersion, or wherein (a) is carried out on solid plant protein material and the plant protein material is then formed into an aqueous dispersion in (b), preferably wherein (a) is carried out with an impact mill, an air jet mill, a pin mill, a tumbling ball mill, a vibrating ball mill, a vibrating rod mill, stirred media mill, agitated bead mill, or a planetary ball mill.

5. A process according to claim 1, wherein modified plant protein material is contacted with PVA and water either before, during, or after steps (a) and/or (b) to form the aqueous film-forming dispersion.

6. A process according to claim 1, wherein the modified plant protein material is contacted with PVA and water by one of the following:
i. forming an aqueous dispersion of modified plant protein material and mixing with a PVA solution;
ii. mixing a solid mixture of modified plant protein material with a PVA solution;
iii. mixing a solid mixture of modified plant protein material and PVA powders with water; or
iv. adding PVA powder to an aqueous dispersion of modified plant protein material.

7. A process according to claim 1, wherein the modified plant protein material is contacted with PVA and water by a high shear mixing step, preferably by a Silverson mixer.

8. A process according to claim 1, wherein milling the plant protein material is carried out in one of a sonicator, a high-pressure homogeniser and a stirred-media mill.

9. A process according to claim 1, wherein a mixture of modified plant protein material and PVA, both being in solid form, is prepared by co-milling, and then contacted with water.

10. A process according to claim 9, wherein the mixture of modified plant protein material and PVA, both being in solid form, are co-milled in a mill selected from an impact mill, an air jet, a pin mill, a tumbling ball mill, a vibrating ball mill, a vibrating rod mill and a planetary ball mill, to form a milled mixture.

11. A process according to claim 1, wherein a mixture of modified plant protein material and PVA, both being in solid form, is prepared by milling the modified plant protein material and optionally milling PVA separately, and then contacted with water.

12. A process according to claim 1, wherein the plant protein material is co-milled with PVA as an aqueous dispersion.

13. A process according to claim 1, wherein a dispersion of modified plant protein material is prepared by passing an aqueous dispersion of the plant protein material through a high-pressure homogenizer at a pressure of greater than 50 MPa.

14. A process according to claim 1, wherein the temperature of the aqueous dispersion of the plant protein material is kept below 50° C. during milling.

15. A process according to claim 1, wherein the plant protein material is further contacted with a chemical modification agent selected from chaotropic agents, pH change agents, reducing agents such as sodium sulfite, and mixtures thereof.

16. A process according to claim 12, which further comprises the step of drying the modified plant protein dispersion to form a solid modified plant protein powder.

17. A film obtainable by the process according to claim 1.

18. A solid composition comprising PVA and modified plant protein material obtainable by step (a) as defined in claim 1, said composition having a PVA content between 5 weight % and 95 weight % and a plant protein content between 5 weight % and 80 weight %.

19. A solid composition according to claim 18, wherein the composition is in the form of granules having a mean particle size of greater than 250 μm and less than 10 mm.

20. A process for forming the solid composition according to claim 19, wherein the process comprises milling the plant protein material and PVA, either separately or together, and granulating the mixture to form granules.
